(19) United States
(12) Patent Application Publication
(10) Pub. No.: US 2026/0212417 A1
(43) Pub. Date: Jul. 23, 2026

(54) GENERATIVE ARTIFICIAL INTELLIGENCE FOR FINANCIAL PLANNING

(71) Applicant: Wells Fargo Bank, N.A., San Francisco, CA (US)

(72) Inventors: Pawan Kumar Jha, Dublin, CA (US); Ganesh Lakshmanan Thondikulam, Pleasanton, CA (US)

(21) Appl. No.: 19/032,700

(22) Filed: Jan. 21, 2025

(51) Int. Cl. G06Q 40/06; G06Q 40/10

(52) U.S. Cl. CPC G06Q 40/06; G06Q 40/10

(57) ABSTRACT

An example computer system for financial planning can: receive, from third party data sources, financial data; generate, using a generative artificial intelligence model, personalized investment models for users based on the financial data and financial profiles of the users; evaluate, using adaptive machine learning techniques, risks associated with the personalized investment models for the users; generate personalized financial recommendations for the users based on the personalized investment models and evaluated risks, wherein the personalized financial recommendations include financial strategies; continuously update the personalized investment models and financial recommendations by causing the computer system to: detect drift in financial market patterns using online learning algorithms; automatically retrain the generative artificial intelligence model based on the drift; and adjust the financial recommendations based on the generative artificial intelligence model; and provide, through a user interface, the personalized financial recommendations that enable the users to simulate various financial scenarios and adjust investment strategies.

### BACKGROUND

The landscape of personal finance and wealth management is evolving rapidly, driven by advancements changing consumer expectations in this era of digital transformation. Traditional advisory services often fall short in addressing the diverse needs and aspirations of individuals, leading to fragmented approaches and suboptimal outcomes.

Current financial tools, while offering some degree of automation and data analysis, are frequently limited in scope and adaptability, focusing on individual investment strategies or specific aspects of financial planning. These can lack the comprehensive perspective necessary for effective wealth management. The existing solutions typically struggle to bridge the financial planning needs across multiple generations, leading to potential conflicts in long-term wealth preservation and transfer strategies.

### SUMMARY

Examples provided herein are directed to the use of generative artificial intelligence for financial planning.

According to one aspect, an example computer system for financial planning can include: one or more processors; and non-transitory computer-readable storage media encoding instructions which, when executed by the one or more processors, causes the computer system to: receive, from third party data sources, financial data; generate, using a generative artificial intelligence model, personalized investment models for users based on the financial data and financial profiles of the users; evaluate, using adaptive machine learning techniques, risks associated with the personalized investment models for the users; generate personalized financial recommendations for the users based on the personalized investment models and evaluated risks, wherein the personalized financial recommendations include financial strategies; continuously update the personalized investment models and financial recommendations by causing the computer system to: detect drift in financial market patterns using online learning algorithms; automatically retrain the generative artificial intelligence model based on the drift; and adjust the financial recommendations based on the generative artificial intelligence model; and provide, through a user interface, the personalized financial recommendations that enable the users to simulate various financial scenarios and adjust investment strategies.

According to another aspect, a method for financial planning can include: receiving, from third party data sources, financial data; generating, using a generative artificial intelligence model, personalized investment models for users based on the financial data and financial profiles of the users; evaluating, using adaptive machine learning techniques, risks associated with the personalized investment models for the users; generating personalized financial recommendations for the users based on the personalized investment models and evaluated risks, wherein the personalized financial recommendations include financial strategies; continuously updating the personalized investment models and financial recommendations by: detecting drift in financial market patterns using online learning algorithms; automatically retrain the generative artificial intelligence model based on the drift; and adjusting the financial recommendations based on the generative artificial intelligence model; and providing, through a user interface, the personalized financial recommendations that enable the users to simulate various financial scenarios and adjust investment strategies.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for using generative artificial intelligence for financial planning.

FIG. 2 shows example logical components of a server device of the system of FIG. 1.

FIG. 3 shows an example graphical user interface generated by the server device of FIG. 2.

FIG. 4 shows an example interaction diagram illustrating communications generated between the components of the system of FIG. 1.

FIG. 5 shows example physical components of the server device of FIG. 2.

### DETAILED DESCRIPTION

This disclosure relates to the use of generative artificial intelligence for financial planning.

The examples described herein can provide financial planning solution that leverages advanced generative artificial intelligence technology to assist with family wealth management. This can include comprehensive financial advisory services by analyzing market data and generating personalized investment strategies tailored to one or more individual's unique circumstances, objectives, and risk tolerances. In some examples provided herein, the individuals comprise a family or other group that have certain common goals but unique challenges with respect to financial planning.

The concepts herein can use generative AI artificial intelligence (GenAI) algorithms, including Generative Adversarial Networks (GANs) and/or Variational Autoencoders (VAEs), to create and dynamically adapt investment strategies based on evolving market conditions and individual life events. An architecture can include one or more of the following components: a data acquisition module that collects and integrates financial data from various sources, a GenAI model generation module that creates personalized investment models, a risk assessment module that evaluates investment strategies, a personalized financial planning module that delivers tailored recommendations, and a continuous learning module that refines strategies based on user feedback and market changes.

This comprehensive approach combines real-time market analysis, sophisticated risk assessment, and/or personalized portfolio optimization through an intuitive user interface for seamless interaction. Through continuous learning and adaptation, the concept refines recommendations to align with changing dynamics, financial goals, and risk preferences.

The concept can democratize access to sophisticated financial advisory services by empowering groups of all backgrounds to make informed decisions and achieve their long-term financial goals, whether planning for retirement, funding education, or preserving wealth for future generations. This holistic approach ensures that the group's financial needs and aspirations are addressed while enhancing wealth accumulation, preservation, and intergenerational wealth transfer.

In the context of this disclosure, “real-time” refers to the capability to process and respond to data on a minute-by-minute basis rather than at static intervals, encompassing the continuous collection and integration of current market data, stock prices, bond yields, commodity prices, foreign exchange rates, and economic indicators as they become available. The examples provided herein demonstrate this real-time functionality through dynamic updates to AI models and financial recommendations as new data inputs are received, continuous monitoring and evaluation of market conditions with immediate updates to risk assessments, generation and modification of financial advice and portfolio adjustments based on the latest available market data and user circumstances, and immediate delivery of alerts and notifications to users when significant changes in market conditions or personal circumstances warrant attention. This real-time processing ensures that financial recommendations remain current and relevant to changing market conditions, operating on a continuous basis rather than through periodic or scheduled updates, enabling immediate strategy adaptation in response to market changes and allowing for swift adjustments to financial strategies when needed.

There can be various advantages associated with the technologies described herein. For instance, the examples provide significant technical improvements over conventional financial planning systems through innovative technological solutions that address specific challenges in family wealth management. This addresses fundamental technical limitations found in traditional approaches, including insufficient personalization capabilities, limited real-time adaptability, lack of integration across wealth management aspects, inadequate risk assessment methods, and inability to bridge generational planning gaps.

The examples implement a sophisticated technical solution through its advanced data processing architecture. This architecture includes a specialized data acquisition and integration module that processes both structured and unstructured data in real-time, utilizing machine learning for automated data cleaning and normalization. The disclosure employs innovative GANs for synthetic data generation to fill data gaps and improve model accuracy, while leveraging state-of-the-art GenAI algorithms to create personalized investment models through continuous learning.

The real-time processing capabilities of these examples represent a significant technological advancement. The disclosure can process financial data and updates recommendations in minutes rather than at static intervals, maintaining continuous connectivity with multiple data sources while enabling dynamic strategy adaptation based on market changes. This real-time functionality ensures that financial recommendations remain current and relevant to changing market conditions.

The practical applications of these examples span multiple sectors within the financial services industry. Family wealth management firms can provide enhanced advisory services, retail banks can offer advanced personalized financial planning, and independent financial advisors gain access to sophisticated AI-driven tools. The utility can also extend to insurance companies and employee benefits providers, enabling them to offer enhanced product offerings through personalized risk assessment and comprehensive financial planning tools.

The implementation produces measurable technical effects through improved processing efficiency. The disclosure achieves this through real-time data integration and analysis, automated data preprocessing and normalization, and continuous model adaptation without manual intervention. Enhanced accuracy is achieved through multi-source data validation, synthetic data generation for improved model training, and dynamic risk assessment updates.

The practical utility of the disclosure is demonstrated through its ability to generate personalized financial strategies for each individual, conduct real-time market analysis and risk assessment, and provide comprehensive wealth management across generations. This technical implementation represents a significant advancement over conventional methods, providing a practical solution to specific technical problems in the field of family wealth management through innovative computing technologies.

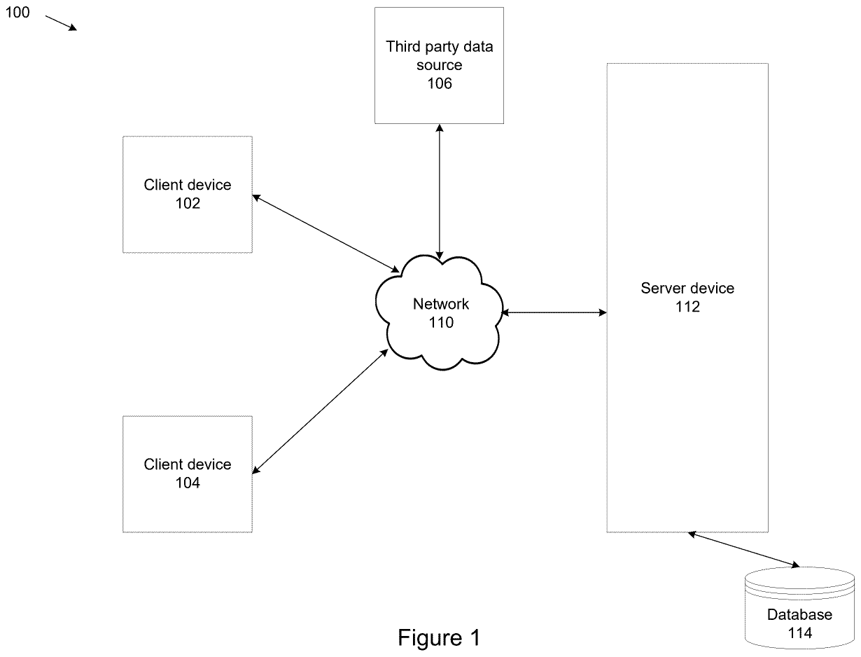

FIG. 1 schematically shows aspects of one example system 100 programmed to use generative artificial intelligence for financial planning. In this example, the system 100 can be a computing environment that includes a plurality of client and server devices. In this instance, the system 100 includes client devices 102, 104, a third party data source 106, a server device 112, and a database 114. The client devices 102, 104 and the third party data source 106 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client devices 102, 104 and the third party data source 106 can be programmed to communicate with the server device 112 to utilize generative artificial intelligence for financial planning. Many other configurations are possible.

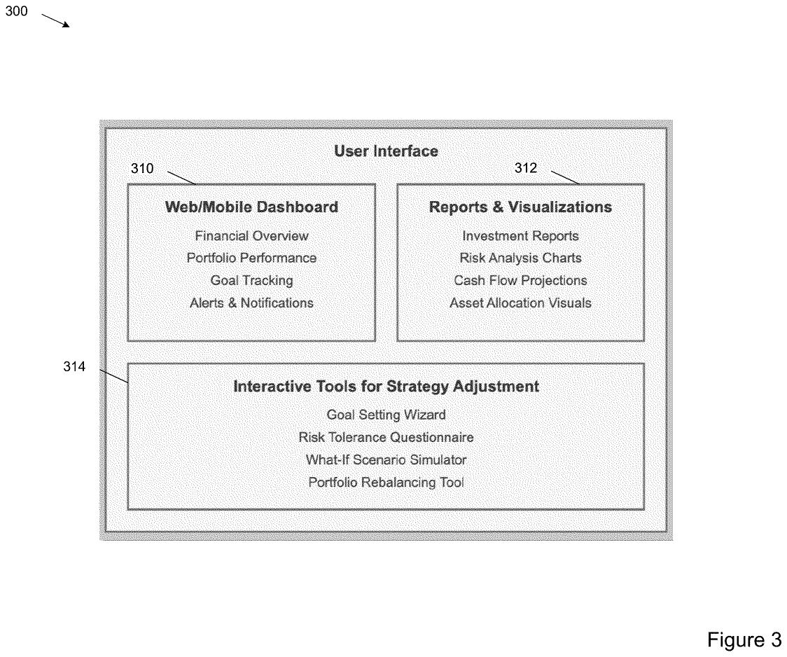

The example client devices 102 and 104 are programmed to allow users to access and engage with the system 100 through one or more graphical user interfaces, such as that shown in FIG. 3. In these examples, a diverse range of users can utilize the system 100, from individual family members seeking comprehensive financial planning across generations to financial services professionals enhancing their advisory capabilities. The system 100 accommodates users with varying levels of financial literacy, including family wealth management firms, independent financial advisors, retail banking professionals, insurance company representatives, and employee benefits providers who utilize the platform to deliver enhanced financial services and personalized risk assessments.

Educational institutions and non-profit organizations can also leverage the system 100 to promote financial literacy and provide planning resources to underserved communities, while all users interact through an intuitive web and mobile-based dashboard that provides personalized recommendations, real-time alerts, and interactive tools tailored to their specific needs and expertise levels.

Through these devices 102, 104, users can view real-time financial reports and visualizations, receive personalized recommendations, and utilize dynamic strategy adjustment tools. The devices 102, 104 can also enable users to request and receive financial data, review personalized investment recommendations, and update their financial plans based on changing circumstances. Users can interact with the system to explore different investment options, track their financial goals, receive real-time alerts regarding significant changes in their financial plans or market conditions, and access detailed reports including investment analysis, risk assessments, cash flow projections, and asset allocation visuals.

The client devices 102, 104 can also facilitate continuous feedback and adaptation by allowing users to provide input on recommendations and interact with the system's simulation tools, which helps refine and improve the personalized financial strategies generated by the system 100.

The example third party data source 106 can be one or more devices that are located externally from the system 100 and/or are configured to communicate with one or more external devices. In these examples, the third party data source 106 can be one or many devices located remotely or within the system 100. Examples of such third party data sources include, without limitation, financial data providers like stock exchanges for real-time equity market data, bond market information providers, commodity price feeds, and foreign exchange rate services to power its comprehensive analysis.

The third party data source 106 can also include economic information sources for indicator databases and interest rate data, as well as news organizations and social media platforms for unstructured data analysis. Further examples of third party data sources include personal financial data aggregators (e.g., Plaid or Yodlee) that provide expense and financial information, while market analysis sources supply volatility data and historical performance metrics.

The third party data source 106 is programmed to provide external financial data and information for comprehensive analysis and recommendations provided by the system 100. This can include market data (such as stock prices, bond yields, commodity prices, and foreign exchange rates), economic indicators, news feeds, and social media feeds. The third party data source 106 can also supply historical financial data and economic trends relevant to the current investment environment, which can be used by the system 100 to create a unified dataset. Additionally, the third party data source 106 can provide unstructured data from news organizations and structured market information like equity markets and interest rates that are crucial for the system's real-time analysis and risk assessment capabilities.

The example server device 112 is programmed to house the various modules that can perform the financial planning capabilities of the system 100. The server device 112 processes and analyzes data from multiple sources and collects and standardizes financial data from various external sources and user inputs. In some examples, the server device 112 utilizes GenAI to create personalized investment models tailored to each family member's unique financial goals, life stages, and risk tolerances.

The server device 112 can also be programmed to evaluate potential risks associated with investment strategies, conducting scenario analyses and stress testing. The server device 112 generates tailored recommendations and advisory services based on the processed data and risk assessments. Throughout operations, the server device 112 learns and adapts using a feedback loop, continuously refining its recommendations by incorporating user interactions, market dynamics, and evolving financial trends to ensure the system remains responsive to changing circumstances.

In these examples, the server device 112 can process these functions in real-time, operating on a minute-by-minute basis rather than providing static analyses, enabling dynamic updates to financial recommendations and risk assessments based on the latest information from multiple origin models.

The example database 114 is programmed as the central data repository for the system 100, storing and managing both user-specific financial data and processed external data. The database 114 maintains records of individual financial profiles, including assets, liabilities, income, and expenses of each family member, as well as historical data about past financial performance and market trends. The database 114 also stores the personalized investment models and strategies generated by the system, risk assessments, and the continuous feedback data that enables the system's learning and adaptation mechanisms.

Additionally, the database 114 can retain preprocessed and normalized financial data from various external sources, ensuring that the system has access to a unified dataset for generating real-time financial recommendations and conducting dynamic portfolio optimizations. Through this comprehensive data storage and management capability, the database enables the system to maintain historical context while supporting real-time analysis and minute-by-minute updates to financial strategies.

The network 110 provides a wired and/or wireless connection between the devices 102, 104, 106 and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

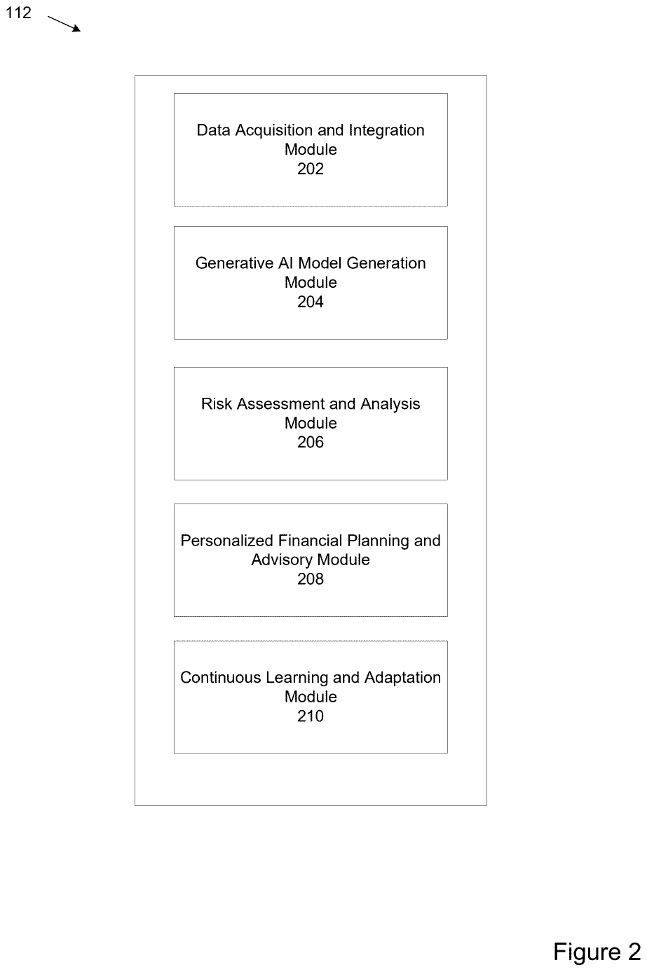

Referring now to FIG. 2, additional details are shown of the server device 112 of the system 100. In this example, the server device 112 has various logical modules that use GenAI for financial planning. The server device 112 can, in this instance, include the various modules described below. In other examples, more or fewer modules providing different functionality can be used.

A data acquisition and integration module 202 of the server device 112 is programmed to collect, standardize, and integrate data from various sources, such as the third party data source 106. The data acquisition and integration module 202 can interface with external data providers to gather real-time market data, including stock prices, bond yields, commodity prices, and foreign exchange rates, as well as collecting financial profiles containing information about assets, liabilities, income, and expenses of each family member. The module also processes historical data, including past financial performance and economic trends relevant to the current investment environment.

The data acquisition and integration module 202 can be programmed to pre-process data, employing machine learning techniques to automatically clean and normalize large datasets. This preprocessing ensures that financial data from various external sources, including stock market data and news feeds, is properly standardized and ready for immediate use by the AI models. The module maintains high accuracy and reliability while processing external and user data in real-time.

The data acquisition and integration module 202 can include a sophisticated Synthetic Data Generation Module that utilizes GANs, as described further below, to create high-fidelity synthetic financial data. This synthetic data serves multiple purposes, including filling in gaps in existing data, improving model accuracy, and testing various financial strategies under different hypothetical conditions.

The implementation includes a data quality control mechanism that is programmed to assess the synthetic data to maintain the same high standards as real-world data, preserving the integrity and predictive accuracy of the AI models generated by a GenAI model generation module 204 of the system 100 while enabling the system to simulate missing or incomplete data for robust AI model training and testing.

More specifically, data quality control mechanism within the data acquisition and integration module 202 employs sophisticated validation techniques to ensure synthetic data maintains consistency with real-world financial trends and behavior. The mechanism continuously monitors and validates the synthetic data generated by the GAN by comparing it against established patterns from real financial data, ensuring that the generated data exhibits realistic market behaviors, correlations, and statistical properties that align with actual financial markets.

For instance, the data acquisition and integration module 202 can ensure incoming data (including real-time market data and user data) is cleaned and standardized through a preprocessing function. This process can include data normalization that scales the data to a range. The Synthetic Data Generation component employs GANs to create realistic financial data, and the GAN is trained using specific loss functions. These mathematical models enable the system to process real-world financial data while generating high-quality synthetic data to fill gaps and improve model training.

This quality control process includes automated verification of data integrity, consistency checks across multiple financial parameters, and validation of the synthetic data's predictive accuracy when used in the system's AI models. Through this comprehensive quality control approach, the mechanism ensures that any synthetic data used for filling gaps or testing strategies maintains the same high standards as real-world data, thereby preserving the reliability and accuracy of the financial analysis and recommendations provided by the system 100.

The data acquisition and integration module 202 can be configured to process both structured and unstructured data, handling information from various sources including news organizations, equity markets, and interest rates. The data acquisition and integration module 202 creates a unified dataset that can be utilized by other components of the system, ensuring that all financial analysis and recommendations are based on comprehensive, up-to-date information. The real-time data integration capability enables the system to dynamically update financial recommendations and risk assessments based on the latest information from external sources.

The data acquisition and integration module 202 can maintain continuous connectivity with third-party data sources to ensure ongoing access to critical external financial data and information. This includes processing of social media feeds, economic indicators, and news feeds, which are essential for the system's comprehensive analysis and recommendations. The data acquisition and integration module 202 can be programmed to handle multiple data streams simultaneously while maintaining data quality and consistency is crucial for the system's real-time analysis capabilities.

As noted above, the data acquisition and integration module 202 processes and standardizes data from various sources to create a unified dataset that is then fed into the GenAI model generation module 204 for creating personalized investment models. The GenAI model generation module 204 utilizes this preprocessed and quality-controlled data to train its GANs and VAEs, enabling the generation of personalized investment strategies and synthetic financial scenarios while continuously updating its models based on the real-time data stream provided by the data acquisition and integration module.

More specifically, the GenAI model generation module 204 is programmed to create personalized investment models tailored to each user's unique financial situation, goals, and risk tolerance. This GenAI model generation module 204 leverages advanced GenAI techniques, specifically GANs and VAEs as described above, to generate and continuously refine these models.

The GenAI model generation module 204 begins by processing standardized data received from the data acquisition and integration module 202, which involves normalizing financial data across different asset classes and time scales, encoding categorical variables, and handling missing data through advanced imputation techniques. The GenAI model generation module 204 can implement a sophisticated GAN architecture comprising two primary components: a generator network that creates synthetic financial scenarios and investment strategies based on input data, and a discriminator network that evaluates these generated scenarios by distinguishing between synthetic and real financial data.

For instance, the GenAI model generation module 204 (along with data from the data acquisition and integration module 202) can implement a synthetic data generation module that utilizes a GAN architecture including the generator network and the discriminator network. The generator network creates synthetic financial scenarios and investment strategies based on input data, while the discriminator network evaluates these generated scenarios by distinguishing between synthetic and real financial data.

Through adversarial training, where the generator and discriminator networks are trained iteratively, the generator learns to produce increasingly realistic and effective investment strategies that can be used to fill gaps in existing data, improve model accuracy, and test various financial strategies under different hypothetical conditions. The GenAI model generation module 204 can also employ VAE architecture, which includes an encoder network that compresses input financial data into a latent space representation and a decoder network that reconstructs financial scenarios and investment strategies from this latent space.

The GenAI model generation module 204 can incorporates data from the personalized financial planning and advisory module 208, as described further below, that utilizes transfer learning techniques to adapt pre-trained general models to individual users'financial profiles. This GenAI model generation module 204 employs reinforcement learning algorithms to optimize investment strategies based on simulated outcomes and user feedback. The GenAI model generation module 204 also implements multi-objective optimization through techniques such as Pareto optimization to balance multiple, often competing financial objectives, such as growth versus stability and short-term gains versus long-term security.

For uncertainty quantification, the GenAI model generation module 204 can implement Bayesian neural networks to provide probabilistic predictions, offering a measure of confidence in generated investment strategies. The GenAI model generation module 204 integrates explainable AI components, including techniques like SHAP (SHapley Additive explanations) values, to provide interpretable insights into the factors driving the generated investment strategies.

The GenAI model generation module 204 also facilitates continuous learning, in conjunction with a continuous learning and adaptation module 210, that utilizes online learning algorithms to update the models in real-time as new market data and user feedback become available. This mechanism implements concept drift detection to identify when significant changes in the financial environment necessitate model retraining. Through this comprehensive approach, the module ensures that investment strategies remain current and optimized for changing market conditions and individual circumstances.

In other examples, the GenAI model generation module 204 can utilize time-series financial data representation for portfolio performance metrics, interactive financial strategy adjustment calculations, financial plan optimization using Markowitz's Portfolio Theory. These mathematical models can utilize Markowitz's mean-variance optimization framework to provide dynamic portfolio optimization.

As described, the GenAI model generation module 204 works in conjunction with other components of the system 100 to deliver comprehensive financial planning solutions. The models generated by the GenAI model generation module 204 are into a risk assessment and analysis module 206 and a personalized financial planning and advisory module 208, ensuring that recommendations capture the complex dynamics of both individual financial situations and broader market trends.

The risk assessment and analysis module 206 is programmed to evaluate potential risks associated with different investment strategies by analyzing market volatility, economic indicators, and personal financial goals. The risk assessment and analysis module 206 employs sophisticated risk assessment algorithms to quantify various risk factors, including volatility, market uncertainty, and correlation analysis. The risk assessment and analysis module 206 considers each user's risk tolerance and investment objectives to provide personalized risk assessments, enabling informed decision-making.

The risk assessment and analysis module 206 utilizes AI-driven techniques, such as the models generated by the GenAI model generation module 204, which combine continuous learning algorithms with real-time data processing. Unlike traditional risk models that operate on fixed parameters, the risk assessment and analysis module 206 uses adaptive machine learning techniques such as multi-horizon predictive models and ensemble learning. These techniques allow the module to anticipate future market changes and user behavior, continuously updating the risk profile of each individual.

In this context, the risk assessment and analysis module 206 can incorporate dynamic, multi-horizon predictive capabilities. For example, when assessing the risk of a family member's investment portfolio, the module might analyze multiple time horizons simultaneously—short-term (market volatility), medium-term (economic cycles), and long-term (demographic trends)—to create a comprehensive risk profile. To illustrate using the multi-horizon predictive model: consider a family member working in the technology sector planning for retirement. The risk assessment and analysis module 206 could analyze:
short-term horizon (1-6 months): evaluating immediate market volatility and sector-specific risks like potential tech industry layoffs;
medium-term horizon (1-5 years): assessing economic cycle impacts on tech sector employment and investment performance; and
long-term horizon (5+ years): analyzing demographic trends affecting retirement planning and long-term tech industry evolution.

The risk assessment and analysis module 206 continuously updates these risk assessments by incorporating real-time data and user feedback through its adaptive learning mechanisms. For instance, if the risk assessment and analysis module 206 detects increasing layoff trends in the tech sector, it would automatically adjust the short-term risk assessment while simultaneously evaluating the potential impact on medium and long-term horizons. This multi-horizon approach enables more precise risk prediction than traditional fixed-parameter models by considering the complex interplay of various risk factors affecting a family's wealth across different time periods.

An ensemble learning component of the risk assessment and analysis module 206 can further enhance this capability by combining multiple predictive models, each specialized for different time horizons and risk types, to generate more robust and accurate risk assessments.

This comprehensive approach helps users navigate volatile financial landscapes while maintaining alignment with their long-term financial goals and risk preferences.

The risk assessment and analysis module 206 conducts comprehensive risk evaluation through multiple components, including market risk analysis, personal risk profiling, and risk mitigation strategies. For market risk analysis, the risk assessment and analysis module 206 performs volatility modeling, correlation analysis, Value at Risk (VaR) calculations, and stress testing. The personal risk profiling component evaluates risk tolerance, time horizon analysis, liquidity needs, and income stability assessment for each family member.

The risk assessment and analysis module 206 can be programmed to handle two primary types of risk: external risks such as market and geopolitical factors, and internal risks such as family-specific circumstances like potential job loss in industries experiencing layoffs. The capability of the risk assessment and analysis module 206 to model complex financial scenarios incorporates non-linear market factors and real-time user data to predict risk levels with a higher degree of precision than conventional models. This adaptive risk assessment mechanism provides users with better decision-making tools, helping them navigate volatile financial landscapes while keeping their goals and preferences in focus.

In such an example, the risk assessment and analysis module 206 can focus on the two components: VaR and Expected Shortfall(ES). The VaR model measures potential portfolio value loss over a specified time period at a given confidence level, while the Expected Shortfall measures the average loss beyond the VaR threshold. These mathematical models enable the system to provide comprehensive risk assessment capabilities by quantifying potential losses and evaluating the extent of risk exposure beyond standard threshold levels. The integration of both VaR and ES calculations allows for a more robust risk assessment framework that considers both the probability and magnitude of potential losses in portfolio value.

The risk assessment and analysis module 206 performs scenario analysis by running multiple simulations based on varying market conditions to predict potential outcomes. The risk assessment and analysis module 206 conducts stress testing to evaluate the robustness of investment strategies against extreme market events and recommends adjustments to asset allocations to mitigate identified risks. Through continuous monitoring and analysis in conjunction with the continuous learning and adaptation module 210, the risk assessment and analysis module 206 ensures that risk assessments remain current and relevant to changing market conditions and personal circumstances.

The risk assessment and analysis module 206 works in conjunction with other components of the system 100, particularly receiving input from the GenAI model generation module 204 and providing critical risk assessment data to the personalized financial planning and advisory module 208. This integration ensures that all financial recommendations incorporate comprehensive risk analysis and maintain alignment with each user's risk tolerance and financial objectives.

The personalized financial planning and advisory module 208 is programmed to deliver tailored financial recommendations and advisory services based on the generated investment models and risk assessments produced by other components of the system 100. The personalized financial planning and advisory module 208 provides comprehensive guidance on asset allocation, investment product selection, retirement planning, education funding, insurance coverage, and estate planning. The recommendations address the unique circumstances, goals, and preferences of each user, providing actionable insights to optimize their financial well-being.

The personalized financial planning and advisory module 208 leverages AI algorithms, including reinforcement learning and deep learning, to generate personalized financial strategies. Unlike systems that offer static recommendations based on predefined rules, the personalized financial planning and advisory module 208 employs dynamic AI models that can modify investment portfolios and financial strategies in real-time. These models analyze the user's financial profile, investment goals, family profile, and risk preferences while incorporating external data such as market conditions and economic indicators.

For instance, the personalized financial planning and advisory module 208 can utilize deep neural networks and transformer architectures to predict and generate personalized financial strategies and employs Monte Carlo simulations to evaluate strategy robustness under various market conditions. These mathematical models work in conjunction to enable the system 100 to generate personalized financial strategies and test their effectiveness across multiple market scenarios, providing a comprehensive framework for strategy development and validation.

The personalized financial planning and advisory module 208 provides consequence and action recommendations, such as asset reallocation, based on its analysis. The module delivers these recommendations through an intuitive interface that allows users to interact with their personalized financial plans, including tools for scenario planning, goal tracking, and what-if analysis. Users can adjust their financial goals, risk tolerance, and other parameters to receive updated recommendations in real-time.

For example, if a user working in the technology sector experiences increased layoff risks in their industry, the personalized financial planning and advisory module 208 might provide the following recommendation:

“Based on detected increased volatility in the technology sector employment market, we recommend reallocating 15% of your current tech-heavy stock portfolio to more defensive sectors and increasing your emergency fund allocation. Specifically, we suggest moving $50,000 from high-growth tech stocks to a mix of consumer staples and healthcare sector ETFs, while directing an additional $2,000 monthly from your current income to build a 12-month emergency fund. This reallocation would reduce your portfolio's tech sector exposure from 45% to 30%, better aligning with your stated risk tolerance while maintaining sufficient growth potential for your retirement goals. You can use the what-if scenario simulator to see how this reallocation would have performed under similar historical market conditions, or adjust the suggested percentages based on your comfort level.”

This recommendation demonstrates how the personalized financial planning and advisory module 208 combines real-time risk assessment with personalized financial goals and circumstances to provide actionable guidance that users can further refine through the interactive tools.

The personalized financial planning and advisory module 208 implements sophisticated real-time alerts and notifications that track external data (such as from the third part data source 106), filtering for market trends or shifts that are relevant to individual users'financial goals. This unique combination of personalization and real-time analysis significantly enhances the ability of the system 100 to keep users informed and allow them to adjust their strategies swiftly. The personalized financial planning and advisory module 208 continuously adapts and learns from both user feedback and external data sources, enabling the creation of highly tailored financial plans that evolve over time.

For example, an example of a real-time alert as generated by the personalized financial planning and advisory module 208 might be the following:

URGENT: Significant Tech Sector Development—Major layoffs announced at leading tech companies affecting 15% of the sector workforce. Based on your current employment in the tech industry and portfolio allocation (40% in tech stocks), we recommend immediate review of your risk exposure. Our analysis suggests this trend could impact both your short-term emergency fund requirements and long-term investment strategy. Click to view personalized reallocation recommendations and run scenario analysis or schedule an immediate portfolio review. Current risk level has increased from Moderate to High based on your personal circumstances.”

This alert demonstrates how the system 100 combines external market data with personalized user circumstances to provide timely, relevant notifications that enable swift strategy adjustments while filtering out market noise that is not relevant to the user's specific situation.

The personalized financial planning and advisory module 208 addresses various aspects of wealth management, including retirement planning, education funding, wealth preservation, and legacy planning. For retirement planning, it projects future income needs and recommends savings strategies. The personalized financial planning and advisory module 208 identifies efficient ways to save, for example, for children's education while considering tax advantages and investment growth and develops strategies for protecting and transferring wealth across generations, including estate planning and charitable giving.

Through its integration with other components of the system 100, the personalized financial planning and advisory module 208 ensures that recommendations remain aligned with the family's evolving financial goals and market conditions. The personalized financial planning and advisory module 208 continuously refines its recommendations based on feedback from users and changes in market dynamics, providing an adaptive and comprehensive approach to family wealth management. This integration enables the delivery of sophisticated, AI-driven financial advisory capabilities that enhance wealth accumulation, preservation, and intergenerational transfer.

FIG. 3 shows an example graphical user interface 300 generated by the personalized financial planning and advisory module 208 for users. For instance, the interface 300 can be generated by the server device 112 and transmitted to one of the client devices 102, 104 for display to the user.

In this example, the interface 300 has various modules that are used to convey information to the user. Each of these example modules is described further below.

An example dashboard module 310 of the interface 300 provides a displays key financial metrics and the current state of each user's financial position. This section presents information about assets, liabilities, income, and expenses in an intuitive format that adapts to individual financial goals and preferences. The dashboard module 310 integrates data from various sources, including personal financial aggregators and market data, to provide users with a complete picture of their financial status.

The dashboard module 310 enables users to track and analyze their investment performance in real-time. Users can view detailed investment reports and asset allocation visuals that are continuously updated based on market conditions and portfolio changes. The dashboard module 310 leverages AI-powered predictive insights generated by the personalized financial planning and advisory module 208 to help users make forward-looking decisions rather than relying solely on historical performance data.

The dashboard module 310 allows users to monitor progress toward their financial objectives through interactive tools and visualizations. Users can utilize the goal-setting wizard to establish and modify financial targets, while the system 100 provides real-time updates on goal progression. The dashboard module 310 adapts to changing circumstances, allowing users to adjust their goals and receive updated recommendations based on their modified objectives.

The dashboard module 310 ensures users remain informed about significant changes in their financial plans and market conditions. Users can set personalized alert thresholds and receive immediate AI-driven recommendations based on those alerts, enabling swift strategy adjustments when needed. The system 100 filters market trends and shifts that are specifically relevant to individual users'financial goals, providing targeted notifications that help users maintain alignment with their financial objectives. These real-time alerts are powered by a sophisticated AI engine that continuously monitors external data and user-specific parameters.

An example reports and visualizations module 312 of the interface 300 provides detailed analysis of investment performance and portfolio metrics that are continuously updated based on real-time market data. These reports leverage AI-powered predictive insights to help users make forward-looking decisions rather than relying solely on historical performance data. The investment reports are fully integrated with personalized financial models, offering intuitive presentations that adapt to individual financial goals and preferences.

The reports and visualizations module 312 visualizes risk assessments through sophisticated data visualization tools that display market volatility, economic indicators, and personal risk factors. These charts, as provided by the risk assessment and analysis module 206, incorporate both external risks, such as market and geopolitical factors, and internal risks, such as family-specific circumstances. The visualizations help users understand complex risk scenarios by presenting multi-horizon predictive models and ensemble learning results in an accessible format.

The reports and visualizations module 312 can also provide visual representations of current and projected financial flows, incorporating data from various sources including personal financial aggregators and market data. These projections are dynamically updated based on real-time changes in financial circumstances and market conditions. The system 100 generates visual forecasts that help users understand potential future scenarios and their financial implications.

The reports and visualizations module 312 presents portfolio composition and investment distribution information through interactive charts and graphs. These visualizations enable users to understand their current asset allocation across different investment categories and see how recommended changes might affect their portfolio balance. The asset allocation visuals are integrated with the system's simulation tools, allowing users to observe potential outcomes of different allocation strategies based on real-time market data and AI-generated predictions.

An example interactive tools module 314 of the interface 300 provides an interactive interface for users to establish and modify their financial objectives, such as by using a wizard. The wizard guides users through a structured process of defining both short-term and long-term financial goals while considering their unique circumstances and preferences. The tool continuously adapts to changing circumstances, allowing users to adjust their goals and receive updated recommendations based on their modified objectives.

For example, the wizard generated by the interactive tools module 314 of the interface 300 might guide a user through the following structured process.

Welcome to your Financial Goals Wizard. Let us start by understanding your current situation.

Step 1: Retirement Planning—Based on your age (45) and current tech sector income ($150,000), we recommend a retirement savings goal of $2.5 M. Would you like to adjust this target?

Step 2: Education Planning—We notice you have two children ages 8 and 12. Based on current education cost projections, we recommend setting aside $200,000 per child for college expenses.

Step 3: Emergency Fund—Given your tech sector employment and current market volatility, we suggest increasing your emergency fund target from 6 to 12 months of expenses ($90,000).

Step 4: Investment Strategy—Based on your goals and risk tolerance, we recommend a balanced portfolio with 60% stocks, 30% bonds, and 10% alternatives. You can adjust these allocations using the slider tools to see how different strategies might affect your goal achievement probability.”

Such a wizard can then be continuously adapted by the interactive tools module 314 to modify these recommendations based on real-time changes in the user's circumstances, market conditions, and any adjustments made to the goals through the interactive interface.

The interactive tools module 314 can thereupon mathematically represent these adjustments through a time-series analysis that allows users to modify parameters like risk tolerance, investment horizon, and portfolio composition in real-time. The interface 300 updates financial strategies based on user-adjusted parameters and calculates optimal investment strategies by re-evaluating the utility function that measures user satisfaction with the strategy. This interactive capability allows users to visualize and understand the potential impacts of their financial decisions through real-time feedback and AI-driven recommendations.

The interactive tools module 314 employs sophisticated assessment techniques to evaluate each user's risk tolerance and investment preferences. A questionnaire can be employed and adapted dynamically based on user responses, utilizing AI algorithms to analyze and interpret risk preferences in real-time. This tool helps ensure that investment recommendations and portfolio strategies remain aligned with each family member's individual risk tolerance levels.

The interactive tools module 314 provides a simulator that enables users to test various financial decisions and investment strategies before implementation. The simulator provides a real-time sandbox environment where users can adjust various parameters and immediately observe the projected outcomes based on their unique financial situation. This highly interactive feature allows users to simulate multiple financial scenarios while receiving instant feedback based on AI-generated predictions and real-time market data.

For example, the interactive tools module 314 might present the following interactive simulation.

Current Portfolio: 60% stocks (40% tech sector), 30% bonds, 10% cash. Let us simulate adjusting your allocation given recent tech sector volatility.

Scenario A—Reducing Tech Exposure: Move 20% from tech stocks to defensive sectors. The simulator shows this would have reduced portfolio volatility by 25% during similar historical market conditions while maintaining 85% of expected returns.

Scenario B—Increasing Emergency Fund: Redirect $2,000 monthly from stock investments to cash reserves.

Based on current market conditions and your tech sector employment, this simulation shows a 90% probability of maintaining adequate emergency funds through a potential 6-month downturn. Real-time Market Impact: Given today's tech sector decline of 3%, the simulator projects Scenario A would have preserved $15,000 in portfolio value. Use the sliders to adjust these allocations and see updated projections or click ‘Compare Scenarios’ to view detailed risk-return metrics for each option.

The interactive tools module 314 continuously updates these projections using real-time market data and AI-generated predictions, allowing users to make informed decisions about potential strategy adjustments.

The interactive tools module 314 offers dynamic portfolio adjustment capabilities that help users maintain optimal asset allocation aligned with their investment goals and risk tolerance. The tool provides real-time recommendations for portfolio adjustments based on market conditions, risk assessments, and personal financial objectives. Users can visualize potential outcomes of different rebalancing strategies through interactive visualizations, while receiving AI-driven recommendations for portfolio optimization.

The system 100 can provide many other graphical user interfaces. For instance, in another alternative, the system 100 can include a personalization and advisory interface that is programmed to provide personalized financial plans that encompass retirement planning, education funding strategies, estate planning, and tax optimization recommendations, which are continuously adapted based on user-specific data and changing market conditions. The interface can also include an investment portfolios component enables dynamic portfolio management through AI-driven recommendations that adjust asset allocations in real-time based on market conditions and user preferences, while providing detailed investment reports and visualization tools that help users understand their current positions and potential adjustments.

Further, such an interface could include a real-time alerts and notifications system employs an AI engine that continuously monitors external data sources and filters market trends specifically relevant to individual users'financial goals, providing immediate notifications about significant market changes or personal circumstance shifts that might require strategy adjustments, while enabling users to set personalized alert thresholds and receive instant AI-driven recommendations based on those alerts. Many other configurations are possible.

Referring again to the server device 112 shown in FIG. 2, the continuous learning and adaptation module 210 is programmed to function as a feedback loop that continuously learns from user interactions, market dynamics, and evolving financial trends. The continuous learning and adaptation module 210 allows the system 100 to refine its recommendations over time by incorporating user feedback and adapting to changes in market conditions or life events. Through this continuous monitoring and adaptation, the continuous learning and adaptation module 210 ensures that investment strategies remain current and optimized for changing market conditions and individual circumstances.

The continuous learning and adaptation module 210 utilizes online learning algorithms to update the models in real-time as new market data and user feedback become available. The continuous learning and adaptation module 210 implements concept drift detection to identify when significant changes in the financial environment necessitate model retraining. This capability enables the continuous learning and adaptation module 210 to retrain AI models without manual intervention, ensuring that the system evolves dynamically in response to new data inputs and user behavior.

The drift detection performed by the continuous learning and adaptation module 210 can be used to identify significant shifts in financial market patterns and user behavior that could impact the effectiveness of existing models. For example, when analyzing a tech sector portfolio, the drift detection might identify a fundamental shift in how tech stocks respond to interest rate changes compared to historical patterns.

Here is a detailed example of how such drift detection might work. Consider a scenario where the system 100 has established models based on traditional correlations between tech stock performance and interest rates. If the Federal Reserve announces a new monetary policy framework, the drift detection mechanism might observe that tech stocks no longer respond to interest rate changes as they historically did. The system 100 would detect this “drift” through continuous monitoring of prediction accuracy and model performance metrics.

When such a drift is detected, the continuous learning and adaptation module 210 initiates automated model retraining. In our example, this might involve:
identifying the specific model components affected by the changed interest rate relationships;
gathering recent market data that reflects the new correlation patterns;
automatically retraining the affected models using the updated data; and
validating the retrained models against current market conditions.

The ability to detect and respond by the continuous learning and adaptation module 210 allows investment recommendations to remain relevant even as market dynamics evolve.

For instance, if the retrained models show that tech stocks have become more resilient to interest rate changes, the system 100 could automatically adjust its risk assessments and portfolio recommendations accordingly, without requiring manual intervention. This continuous adaptation helps maintain the accuracy of financial advice even during periods of significant market transformation.

The continuous learning and adaptation module 210 incorporates reinforcement learning techniques to optimize investment strategies based on simulated outcomes and user feedback. The continuous learning and adaptation module 210 gathers data on user actions and outcomes, feeding this information back into the AI engine to improve future recommendations. The adaptive algorithms within the continuous learning and adaptation module 210 adjust its models in response to changing market conditions and life events, such as job changes, births, or retirements.

The continuous learning and adaptation module 210 can proactively notify users, such as the through the interface 300 or other mechanism (e.g., email, text message, etc.), when significant changes in market conditions or personal circumstances warrant a reassessment of their financial plan. This real-time monitoring and notification ensure that the continuous learning and adaptation module 210 can quickly respond to changing circumstances and provide updated recommendations. The continuous learning and adaptation module 210 filters market trends and shifts that are specifically relevant to individual users'financial goals, providing targeted notifications that help users maintain alignment with their financial objectives.

In one example, the continuous learning and adaptation module 210 uses mathematical models that encompass two components: reinforcement learning for strategy adaptation and Policy Updates. The reinforcement learning component utilizes a state-action value function that can be updated using the Bellman equation. The policy update mechanism adjusts the strategy policy. These mathematical models enable the system 100 to continuously learn and adapt its financial strategies based on both user feedback and observed market performance, ensuring that the system's recommendations remain optimized and relevant as market conditions and user circumstances evolve over time.

The continuous learning and adaptation module 210 works in conjunction with other components of the system 100 to ensure comprehensive adaptation of financial strategies. The continuous learning and adaptation module 210 can provides feedback to the GenAI model generation module 204 for updating investment models, informs the risk assessment module of changing risk factors, and helps the personalized financial planning module refine its recommendations. Through this integrated approach, the continuous learning and adaptation module 210 ensures that all aspects of the system remain responsive to changing circumstances and continue to provide optimal financial guidance.

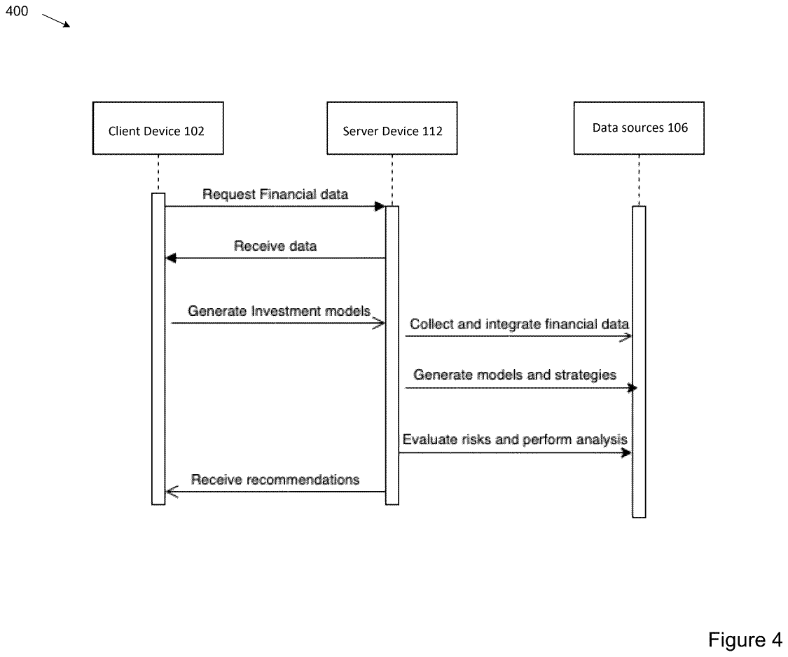

FIG. 4 shows an example interaction diagram 400 illustrating communications generated between the components of the system 100. The diagram illustrates the communication flow between a user of the client device 102, the server device 112, and third party data sources 106. The diagram 400 depicts how users of the client device 102 initiate requests for financial data and receive recommendations, while the server device 112 of the system 100 processes these requests through data collection, model generation, and risk evaluation stages. The system 100 maintains continuous communication with financial data sources to ensure real-time data integration and analysis.

The interaction sequence in the diagram 400 begins with a user of the client device 102 requesting financial data from the system 100. This initiates a process where the system 100 collects and integrates financial data from various sources (e.g., both internally and through the third party data source 106), generates personalized investment models and portfolio allocation strategies, evaluates associated risks, and finally delivers personalized recommendations to the client device 102 for the user.

Another interaction sequence of the diagram 400 involves receiving recommendations and updating financial plans. This process includes the server device 112 of the system 100 providing personalized recommendations based on generated investment models and risk assessments, users of the client device 102 reviewing these recommendations, and requesting updates to their financial plans. The system 100 then regenerates investment models and strategies based on new data, performs updated risk analysis, and delivers revised recommendations.

The system 100 can be applied across multiple sectors within the financial services industry and beyond. The system 100 can be integrated into family wealth management firms to enhance advisory services and retail banking institutions to offer advanced financial advisory services to customers. Additional applications include supporting independent financial advisors with AI-driven tools, enabling insurance companies to enhance their offerings through personalized risk assessment, improving employee benefits packages with comprehensive financial planning tools, and facilitating financial literacy education through educational institutions. The system 100 can also has applications in non-profit organizations, where it can be used to expand reach and impact by offering access to personalized financial planning tools and resources to empower individuals and families from underserved communities.

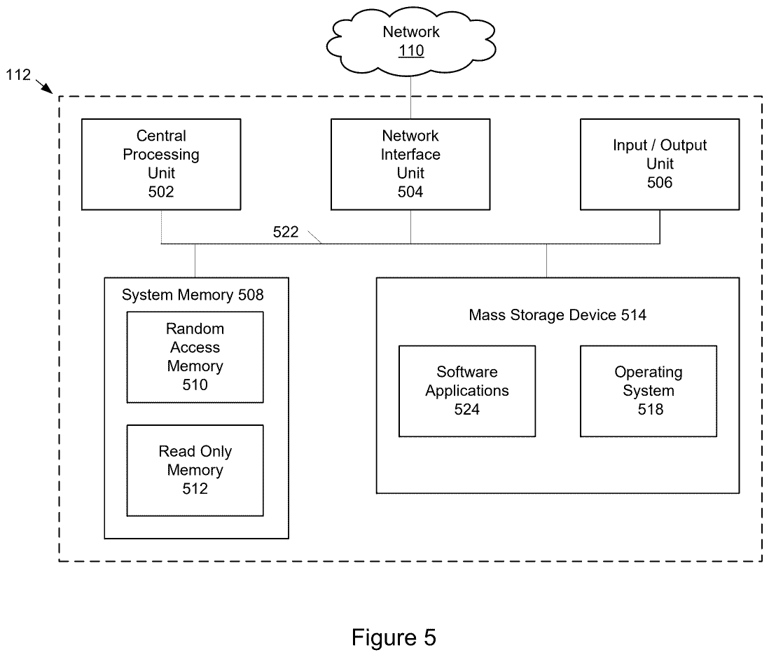

As illustrated in the embodiment of FIG. 5, the example server device 112, which provides the functionality described herein, can include at least one central processing unit (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system containing the basic routines that help transfer information between elements within the server device 112, such as during startup, is stored in the ROM 512. The server device 112 further includes a mass storage device 514. The mass storage device 514 can store software instructions and data. A central processing unit, system memory, and mass storage device similar to that shown can also be included in the other computing devices disclosed herein.

The mass storage device 514 is connected to the CPU 502 through a mass storage controller (not shown) connected to the system bus 522. The mass storage device 514 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 504 connected to the system bus 522. It should be appreciated that the network interface unit 504 may also be utilized to connect to other types of networks and remote computing systems. The server device 112 also includes an input/output controller 506 for receiving and processing input from a number of other devices, including a touch user interface display screen or another type of input device. Similarly, the input/output controller 506 may provide output to a touch user interface display screen or other output devices.

As mentioned briefly above, the mass storage device 514 and the RAM 510 of the server device 112 can store software instructions and data. The software instructions include an operating system 518 suitable for controlling the operation of the server device 112. The mass storage device 514 and/or the RAM 510 also store software instructions and applications 524, that when executed by the CPU 502, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for financial planning, comprising:
one or more processors; and
non-transitory computer-readable storage media encoding instructions which, when executed by the one or more processors, cause the computer system to:
receive, from third party data sources, real financial data through connectivity with multiple data streams;
generate synthetic financial data using a generative adversarial network architecture comprising a generator network that creates synthetic financial scenarios based on input data, and a discriminator network that evaluates the synthetic financial scenarios by distinguishing between the synthetic financial data and the real financial data, wherein the generator network and the discriminator network are trained iteratively through adversarial training such that the generator network learns to produce realistic synthetic financial scenarios;
validate the synthetic financial data through comparison with patterns from the real financial data to develop realistic market behaviors and statistical properties;
combine, upon validation, the synthetic financial data with the real financial data to create an augmented training dataset, wherein the synthetic financial data fills in historical gaps in the real financial data to allow for improved model training;
generate, using a generative artificial intelligence model trained with the augmented training dataset, personalized investment models for users based on the real financial data and financial profiles of the users;
evaluate, using adaptive machine learning techniques, risks associated with the personalized investment models for the users;
generate personalized financial recommendations for the users based on the personalized investment models and evaluated risks, wherein the personalized financial recommendations include financial strategies;
continuously update the personalized investment models and financial recommendations by causing the computer system to:
detect drift in financial market patterns using online learning algorithms;
automatically retrain the generative artificial intelligence model based on the drift; and
adjust the financial recommendations based on the generative artificial intelligence model; and
provide, through a user interface, the personalized financial recommendations that enable the users to simulate various financial scenarios and adjust investment strategies.

2. (canceled)

3. The computer system of claim 1, wherein, to evaluate risk, the instructions further cause the computer system to:
analyze short-term market volatility, medium-term economic cycles, and long-term demographic trends using multi-horizon predictive models;
evaluate personal risk factors including employment sector risks and family-specific circumstances; and
generate risk mitigation strategies.

4. The computer system of claim 1, wherein the instructions further cause the computer system to generate:
a wizard that guides the users through defining financial objectives based on their unique circumstances;
a risk tolerance questionnaire that dynamically adapts based on user responses;
a simulator for testing various financial decisions; and
a portfolio rebalancing tool that provides real-time allocation recommendations.

5. The computer system of claim 1, wherein, to generate the personalized financial recommendations, the instructions further cause the computer system to:
analyze retirement planning needs based on projected income requirements;
develop education funding strategies considering tax advantages;
create wealth preservation and transfer strategies across generations; and
provide asset allocation recommendations across different investment categories.

6. The computer system of claim 1, wherein the instructions further cause the computer system to:
use the synthetic financial data for testing the financial strategies.

7. The computer system of claim 1, wherein, to detect the drift, the instructions further cause the computer system to:
monitor prediction accuracy and model performance metrics;
identify changes in established market pattern correlations; and
initiate model retraining when significant pattern changes are detected.

8. The computer system of claim 1, wherein the instructions further cause the computer system to:
provide visualization tools for displaying investment reports, risk analysis charts, and asset allocation data;
enable dynamic adjustment of financial strategies through interactive interfaces; and
generate real-time alerts based on personalized alert thresholds.

9. The computer system of claim 1, wherein the adaptive machine learning techniques comprise:
reinforcement learning algorithms that optimize investment strategies based on simulated outcomes;
transfer learning techniques that adapt pre-trained models to individual user profiles; and
ensemble learning that combines multiple specialized models for risk assessment.

10. The computer system of claim 1, wherein the instructions further cause the computer system to:
process both structured and unstructured data from the third party data sources;
normalize the real financial data across different asset classes and time scales; and
create a unified dataset for generating the personalized investment models.

11. A method for financial planning, comprising:
receiving, from third party data sources, real financial data through connectivity with multiple data streams;
generating synthetic financial data using a generative adversarial network architecture comprising a generator network that creates synthetic financial scenarios based on input data, and a discriminator network that evaluates the synthetic financial scenarios by distinguishing between the synthetic financial data and the real financial data, wherein the generator network and the discriminator network are trained iteratively through adversarial training such that the generator network learns to produce realistic synthetic financial scenarios;
validating the synthetic financial data through comparison with patterns from the real financial data to develop realistic market behaviors and statistical properties;
combining, upon validation, the synthetic financial data with the real financial data to create an augmented training dataset, wherein the synthetic financial data fills in historical gaps in the real financial data to allow for improved model training;
generating, using a generative artificial intelligence model trained with the augmented training dataset, personalized investment models for users based on the real financial data and financial profiles of the users;
evaluating, using adaptive machine learning techniques, risks associated with the personalized investment models for the users;
generating personalized financial recommendations for the users based on the personalized investment models and evaluated risks, wherein the personalized financial recommendations include financial strategies;
continuously updating the personalized investment models and financial recommendations by:
detecting drift in financial market patterns using online learning algorithms;
automatically retraining the generative artificial intelligence model based on the drift; and
adjusting the financial recommendations based on the generative artificial intelligence model; and
providing, through a user interface, the personalized financial recommendations that enable the users to simulate various financial scenarios and adjust investment strategies.

12. (canceled)

13. The method of claim 11, further comprising analyzing short-term market volatility, medium-term economic cycles, and long-term demographic trends using multi-horizon predictive models;
evaluating personal risk factors including employment sector risks and family-specific circumstances; and
generating risk mitigation strategies.

14. The method of claim 11, further comprising:
providing a wizard that guides the users through defining financial objectives based on their unique circumstances;
providing a risk tolerance questionnaire that dynamically adapts based on user responses;
providing a simulator for testing various financial decisions; and
providing a portfolio rebalancing tool that provides real-time allocation recommendations.

15. The method of claim 11, further comprising:
analyzing retirement planning needs based on projected income requirements;
developing education funding strategies considering tax advantages;
creating wealth preservation and transfer strategies across generations; and
providing asset allocation recommendations across different investment categories.

16. The method of claim 11, further comprising:
using the synthetic financial data for testing the financial strategies.

17. The method of claim 11, further comprising:
monitoring prediction accuracy and model performance metrics;
identifying changes in established market pattern correlations; and
initiating model retraining when significant pattern changes are detected.

18. The method of claim 11, further comprising:
providing visualization tools for displaying investment reports, risk analysis charts, and asset allocation data;
enabling dynamic adjustment of financial strategies through interactive interfaces; and
generating real-time alerts based on personalized alert thresholds.

19. The method of claim 11, further comprising:
using reinforcement learning algorithms that optimize investment strategies based on simulated outcomes;
using learning techniques that adapt pre-trained models to individual user profiles; and
using ensemble learning that combines multiple specialized models for risk assessment.

20. The method of claim 11, further comprising:
processing both structured and unstructured data from the third party data sources;
normalizing the real financial data across different asset classes and time scales; and
creating a unified dataset for generating the personalized investment models.
